(19) United States
(12) Patent Application Publication
(10) Pub. No.: US 2016/0034841 A1
(43) Pub. Date: Feb. 4, 2016

(54) TEAM WORKFORCE ASSIGNMENT

(71) Applicant: AVAYA INC., Santa Clara, CA (US)

(72) Inventors: Valentine C. Matula, Granville, OH (US); David Skiba, Golden, CO (US); George Erhart, Loveland, CO (US)

(21) Appl. No.: 14/449,620

(22) Filed: Aug. 1, 2014

(51) Int. Cl. G06Q 10/06; H04M 3/523; H04M 3/51

(52) U.S. Cl. CPC G06Q 10/063112; H04M 3/5175; H04M 3/5233

(57) ABSTRACT

A contact center, methods, and mechanisms are provided for dynamically assembling a team of resources to handle a work item. The work item is analyzed for any needs and a suitable team of resources is selected based at least partially on those needs. Each of the resources can be reserved and applied to a work item for a duration of time that the work item is being handled. As the workflow associated with the work item progresses, the needs of the work item are reevaluated for any changes that may require a modification to the team of resources. When the changes require modification, the team of resources can be adjusted on the fly to suit the changing needs of the work item.

### FIELD OF THE DISCLOSURE

The present disclosure is generally directed toward communications and more specifically toward contact centers.

### BACKGROUND

Contact centers can provide numerous services to customers, and have been doing so for years. The idea of a contact center queue is not much different from that of standing in line at a bank and waiting to be helped by the next available teller. However, there can be significant frustration if the first, second, or even third teller cannot answer a given question or set of questions. The same frustrations have been known to occur in contact centers. A company can gain customer satisfaction if they are able to answer their customers' questions quickly and accurately.

Contact centers, such as Automatic Call Distribution or ACD systems, are employed by many enterprises to service customer contacts. A typical contact center includes a switch and/or server to receive and route incoming packet-switched and/or circuit-switched contacts and one or more resources, such as human agents and automated resources (e.g., Interactive Voice Response (IVR) units), to service the incoming contacts.

As products and problems become more complex and diverse in nature, it becomes less likely that a single agent possesses all of the skills or expertise to fully service customer contacts. To service customer contacts more effectively, contact centers route contacts to one or more resources with specific skills and attributes. These attributes and/or skills may include but are not limited to proficiency in spoken languages, technical expertise, communication ability (e.g., sign language, TTY, texting, SMS, email, phone, video phone, and the like), preferred work type, department, and combinations thereof. For example, contact centers that handle computer customer service may have application resources, hardware resources, operating system resources, network resources, etc. While these resources may be well-qualified to answer questions on their particular subject(s), they are often unqualified to answer questions involving subjects outside of their respective skill sets. Still, these resources may be assigned to work items based on at least one attribute, skill, and rule-based match used by a contact center's work assignment mechanism.

Typically, fixed teams of resources may be assigned to provide a number of services to a contact. For example, a fixed team of resources can be created to provide a set of agents for a customer or to provide a mix of skills to suit a customer's situation. These fixed teams are generally assembled once and applied to customers of a contact center. As can be appreciated, a fixed team of resources may include more or less resources than are actually required to achieve consistently high levels of customer service.

It is one goal of a contact center to maintain good customer service when handling contacts, and as such, work items are typically assigned to qualified agents in a timely and efficient manner. In some cases, however, the suboptimal assignment of one or more work items to resources may go unnoticed by a contact center. As a result, suboptimal assignments may continue and contact center performance as well as long-term customer service may suffer.

### SUMMARY

There are many models for providing services to customers. One popular model is to provide multiple people with many and/or different skills to service a particular level and/or type of customer. Typically, fixed teams are assembled once and provide service to a customer as needed. Assigning fixed teams in a contact center provides a consistent set of agents for a customer, or provides the right mix of skills for a customer's situation. However, traditional fixed team assignment cannot provide the best agent or group of agents for all customer contacts. For example, while the needs of a contact may change during a communication with a contact center, the fixed team of resources that have been assigned to the contact remain assigned to the contact throughout the length of the communication.

It is with respect to the above issues and other problems that the embodiments presented herein were contemplated. Among other things, the present disclosure provides methods, devices, and systems that enable a dynamic team workforce assignment to service contacts received at a contact center. For example, the team workforce assignment may be configured to analyze attributes of contacts (e.g., customers, etc.) and resources (e.g., agents, experts, etc.), attributes of work items, and even attributes of queries and past performance. The data may be collected and stored, and the data may be used to automatically select a team of resources for a specific period of time to provide quality service to a customer.

In some embodiments, the team workforce assignment can provide a team of resources (e.g., people, agents, etc.) in real-time, or near-real-time, to respond to a need with in place allocation as dictated by desired skill delivery. As provided herein, the methods and systems for team workforce assignment may include routing, reservation, and allocation components.

The team workforce assignment may be based on multiple layers of needs of a contact, skills of a resource, and/or availability of a resource of a contact center. In one embodiment, the team workforce assignment may assemble a dynamic team of resources to fit a specific need, managing time commitments and busy states, fulfilling the complex routing request of a multiparty service.

Team workforce assignment may utilize a hierarchy of work definition and assignment. In particular, the hierarchy of work definition establishes relationships between different resources and cascading dependencies. Based on these relationships, the team workforce assignment can reserve a main resource along with cascading dependent resources (e.g., resources pulled by the main resource into the team, etc.). Specific skills assignment may be combined with a cascading time component. The allocation and assignment process may be a continual process that runs as components and sub-components of resources are released. Additionally or alternatively, some skills may be reserved, or tagged as optional.

A number of factors may be considered in making dynamic team workforce assignments. For instance, an analysis of previous interactions may be considered by a workforce mechanism in assembling a dynamic team. This analysis may provide information that can be used to select a number of team members and/or types of team members. Another factor considered by the workforce mechanism may include time aspects of a communication with a customer. For example, how many people and who would be on a team may depend upon the length of overall interaction required. The time consideration may include who responds and length of interaction for each member of the team. Other factors may include providing resources who work on specific types of interactions with customers (e.g., insurance claims, mortgage details, investment options, etc.).

One non-limiting example of a team workforce assignment may include a highly-valued investment customer who calls into a contact center to ask estate planning questions. A high-value component may necessitate a planning coordinator who can be allocated and routed to handle the interaction. During the initial contact time, assignments for all cascading skills and resources can be performed by the workforce mechanism. The workforce mechanism may be operable to continuously monitor allocations and to perform removal and/or releasing tasks, as needed.

Continuing this example, a lawyer specializing in document creation may immediately be allocated and possibly added to the call by the planning coordinator. The lawyer may be used for consultation and/or actions to be performed. The allocation state and assignments may remain active after the initial call as other research and/or work is done. Other skills/states that are enacted may result in another layer of team allocation and assignment (e.g., Trust Creation, etc.).

In a second non-limiting example, a person may be sitting at a table of a restaurant with a tablet computer, or other mobile computing device. A “service team” may then be selected to help the person, consisting of two wait staff members and a delivery person/food runner. The person may be presented with a user interface via the mobile computing device that shows pictures of the team members, but does not necessarily explain the roles of each member. Rather than having a fixed team every time the person visits the restaurant, the team is automatically assembled in real-time, or near-real-time, from multiple skills required to support the person's dining experience.

In a third example, the skills needed may not be all mandatory skills. Instead, a value function can be defined that gives the value of meeting each of the potential skills. An example of this skill valuation may be where assigning a legal expert is valued as 100 units with French skills at 30 points, English at 10, and all other languages at −130 (i.e., negative 130). In effect, this scenario would tend to favor a French speaking lawyer over an English speaking lawyer, and negate the value of assigning any other language. By adding a time element such as 100 points for assigning a team within 1 minute, and −500 (i.e., negative 500) points for taking 5 min or longer, the system and workforce mechanism may form partial teams in favor of waiting for all skills to be available.

The method employed by the workforce mechanism can be revisited repeatedly as a workflow with a customer progresses, such that at some point, the values of the skills may change, which in effect will permit a team member to be released. As an example, after the legal component is finished, the value of the legal skill might change to −500 (i.e., negative 500), which would encourage the lawyer to be dropped from the team workforce assignment.

The method may also value “continuity,” so that if an agent is assigned to a team, removing the agent from the team is negatively valued. In this embodiment, during reevaluations of a workflow, it is possible for a team member to be pulled off the team to a higher priority activity, but the removal of the team member may discouraged due to the reduction in the value function.

In some embodiments, the team workforce assignment may reevaluate as a cascading of dependencies occurs and/or a trigger item status is updated. The present disclosure can determine a changing status of an event as an opportunity to examine which resources are needed, will be needed, or are dependent on newly introduced resources. In some cases, the trigger event may be the start of the process.

The present disclosure may reserve resources that may or may not be used in a team. In other words, the present disclosure addresses the need for complex tasks that need continuous monitoring, scheduling, and/or reserving of resources based on the ever changing conditions and progress of the initial trigger item. Among other things, the role of resources may depend on a mandatory, secondary, optional, and/or other category of reservation.

The assignment of the team of resources provided herein can be an ongoing task run through the trigger, servicing, and completion of an event. As can be appreciated, the present disclosure may include changing teams as the workflow progresses. For example, a person may be interested in a medium sized commercial building purchase in New York. To start, a mortgage qualification person (resource), legal assistance (resource), credit verification (resource), and/or other comparable resources may be required. As the deal progresses, most of the aforementioned resources may be released, except for the legal person, and additional resources may be required such as a sales resource, title search resource, closing expert, and a courthouse recording expert. The methods provided herein can at least dynamically assemble and/or modify the team of resources in accordance with this model.

In some embodiments, a contact may include a fractional request of resources based on a likelihood of engagement. For instance, in a call to a contact center a customer may need one agent, and 5% of a supervisor, since in the call center, for every 20 minutes on the phone by an agent, a minute of coach time may be needed live on the call.

In one embodiment, the team workforce assignments provided herein may include reserved off-call times. For example, for every hour of agent time, 3.75 minutes of supervisor feedback time may be needed (e.g., delivered as a 15 minute session every four hours for a new agent, etc.). The system can form a team comprising an agent resource and supervisor resource, and reserves some time at different levels for each of the resources.

In some embodiments, a team of resources may be dynamically assembled via a dynamic workforce mechanism. In general a team of resources includes two or more resources. When a contact is received at a contact center, a work assignment mechanism may determine information associated with the contact. The information associated with the contact can include, but is not limited to, one or more of customer identification, work item information, subject matter, attributes, service level, historical data, average time of handling (e.g., including wait times, processing time, disposition time, etc.), past performance, and the like. A work item may be created by the work assignment mechanism that represents the contact received at the contact center. The information associated with the contact may be included in the work item.

A team of resources may be dynamically assembled to provide one or more services for the work item. In one embodiment, the team of resources may be assembled to suit at least one need, desire, and/or classification of the work item. By way of example, a team of resources may be assembled to include a customer service representative, a supervisor, a sales representative, and/or more service agents/resources for a work item. Each resource of the team of resources may be introduced to the work item at the same time and/or at different times during a communication with the contact center.

Assembling the team of resources may include reserving each resource for an amount of time that is determined for the work item. In some embodiments, the amount of time may be based on historical data associated with one or more of past/similar team resource allocation, contact type, contact identification, work item type, and/or other work item information, etc. In any event, the reservation of each resource may include a time component that at least defines the amount of time that a resource can be reserved. In one example, a work item may define that a supervisor should be reserved for 1/20 of the total time a work item is handled. Additionally or alternatively, the time that the resource may be demanded or desired can be flexible. For instance, the resource may be applied to a work item as the resource is needed. As can be appreciated, the supervisor in the example above may be reserved for 19 other similar work items during the same time (e.g., where each work item defines that the supervisor is to be reserved for 1/20 of the time) such that the supervisor is reserved for a full time that the work items are being handled (e.g., 20/20).

In some embodiments, the resource may be reserved, but may not be used during a communication. In one embodiment, the resource may be reserved and always used during a communication. In any event, this information may be collected and stored in a memory to determine whether the resource can be reserved for more or less time in future, or subsequent, dynamic workforce team assignments. By way of example, a resource may be reserved for a period of time for participation in one or more workforce teams. In the event that the resource is not used during the period of time, or does not participate on one or more of the workforce teams, the resource reservation may be classified for overbooking Overbooking may provide that the resource can accept more reservations for a time period and/or that the resource may be reserved for a greater number of specific workforce teams. The reservation determinations may be made by the dynamic workforce mechanism as provided herein.

The reservations described herein may be stored in a data structure associated with the resource, in a table, in a resource pool, and/or some other memory of a contact center. In some embodiments, the reservation associated with a resource may be modified (e.g., via the dynamic workforce mechanism, etc.) as conditions change. For example, a resource may be reserved by the dynamic workforce mechanism to participate in a number of workforce teams. In the event that at least one of the workforce teams no longer requires the resource (e.g., from a lack of determined need, a completion of a service by the resource, a dropped communication, etc., and/or some other reason) the resource may be released from the reserved status associated with that workforce team. In one embodiment, the release of the resource from the reserved status may open the resource to another reservation by another workforce team. In another embodiment, the release of the resource may allow the resource to use the reserved time for a break, learning opportunity, and/or some other activity.

In some embodiments, a resource that can be assembled as part of a workforce team may be associated with a number of other dependent resources. For instance, a lawyer resource may be associated with a stenographer resource, a legal assistant resource, and/or some other resource. When the resource is assembled as part of a workforce team, the resource may bring the other dependent resources along to participate in the workforce team. As such, the dynamic workforce mechanism in this example need only reserve the resource for a workforce team as the resource can automatically include any dependent resources. Additionally or alternatively, the workforce mechanism can release the resource from the workforce team and any dependent resources may automatically be released. In one embodiment, at least one of the dependent resources may remain on the workforce team when the resource is released.

The dynamic workforce mechanism may be configured to continually reevaluate a team workforce assignment (e.g., resource information, work item information, conditions, status, etc.). The reevaluation may include determining whether a data structure associated with a work item changes from a first time to a second time. Determining a change in the data structure of a work item can indicate that needs and/or desires of a work item have changed. Among other things, this continual reevaluation of the team workforce assignment can serve to dynamically configure a team applied to a work item based at least partially on the changing needs of the work item. In one example, a workforce team may be configured by reserving and/or releasing resources to suit information associated with the work item.

As provided herein, a resource may possess one or more attributes which can include, without limitation, language ability, fluency for a language, level of understanding for a language, skill (e.g., billing, customer service, troubleshooting, accounts receivable, accounts payable, product knowledge, departments, etc.), skill level (e.g., trainer, trainee, expert, associate, etc.), willingness to participate, attitude rating (e.g., via peer, customer, supervisor, technical, survey, etc.), gender, age, nationality, experience, historical KPIs (e.g., call resolution rate, close rate, conversion rate, etc.), busyness, location, availability, presence information, preferred communication type (e.g., media, medium, real-time, near-real-time, non-real-time, etc.), communication device type, and combinations thereof.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

The term “workflow” as used herein may refer to one or more tasks, steps, and requirements associated with handling a work item, or contact, at a specific point in time. As provided herein a typical workflow associated with a work item may employ parallel resource assignments, sequential resource assignments, and/or combinations thereof. For example, a workflow of a work item may include the assignment of a first and second resource to a work item at a first point in time, and the assignment of a third resource to the work at a second time. In this example, the first and second resources may handle, or work with, the work item at the same time (e.g., parallel resource assignment), while the third resource may handle the work item at the second time when the first and second resources are no longer handling the work item (e.g., sequential resource assignment). Aspects of the present disclosure may reevaluate a workflow associated with a work item and manage a workforce assignment based at least partially on the reevaluation. It should be appreciated that the reevaluation may be performed after a work assignment decision has been made. For instance, as a workflow progresses in time, a dynamic workforce mechanism may determine to adjust a team workforce assignment associated with a work item. The determination may cause a management of one or more resources in the team. Management can include altering a future scheduled time of assignment, allocation time, allocation duration, an assignment, assignment start/stop time, and/or the like.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting exemplary pools and bitmaps that are utilized in accordance with embodiments of the present disclosure;

FIG. 3 is a block diagram depicting a work item data structure used in accordance with embodiments of the present disclosure;

FIG. 4 is a block diagram depicting a resource data structure used in accordance with embodiments of the present disclosure;

FIG. 5A is a block diagram depicting a team workforce assignment data structure at a first time in accordance with embodiments of the present disclosure;

FIG. 5B is a block diagram depicting a team workforce assignment data structure at a second time in accordance with embodiments of the present disclosure;

FIG. 6 is a block diagram depicting a team workforce assignment over time in accordance with embodiments of the present disclosure; and

FIG. 7 is a flow diagram depicting a method of dynamic team workforce assignment in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

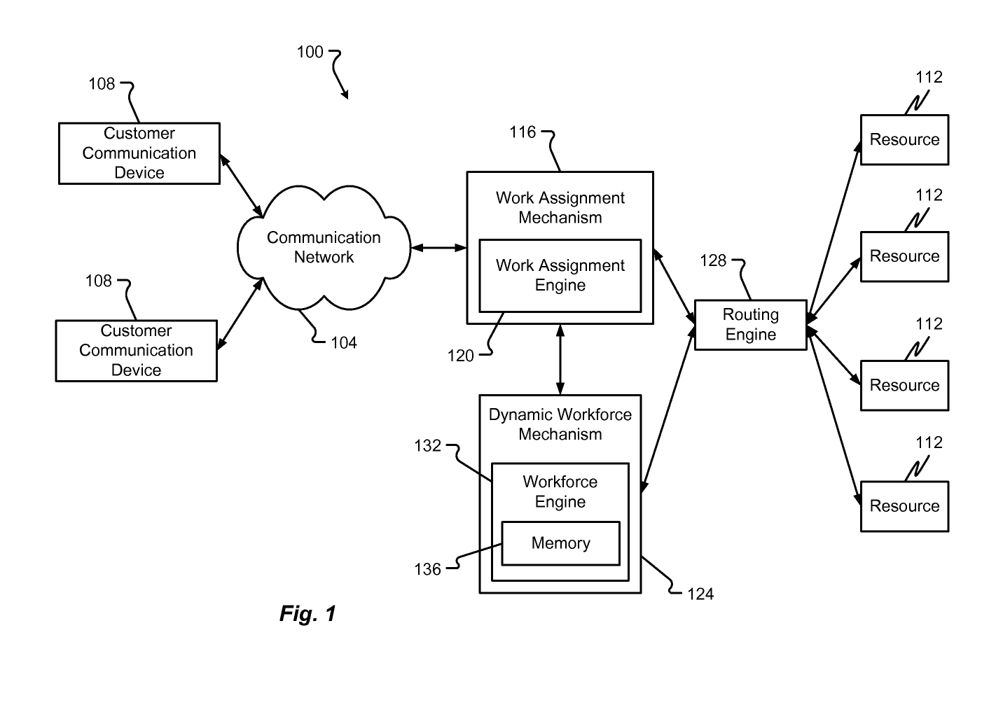

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116 and dynamic workforce mechanism 124, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over Internet Protocol (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference for all that it teaches and for all purposes. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively, each of which are hereby incorporated herein by reference in their entirety for all they teach and for all purposes.

The format of the work item may depend upon the capabilities of the communication device 108 and the format of the communication. In some embodiments, work items are logical representations within a contact center of work to be performed in connection with servicing a communication received at the contact center (and more specifically the work assignment mechanism 116).

Although the routing engine 128 is depicted as being separate from the work assignment mechanism 116, the routing engine 128 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, tablet, mobile computer, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 128.

The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers, and may include contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference for all that it teaches and for all purposes.

More specifically, the work assignment engine 120 can determine which of the plurality of processing resources 112 is eligible and/or qualified to receive a work item and further determine which of the plurality of processing resources 112 is best suited to handle the processing needs of the work item. In situations of work item surplus, the work assignment engine 120 can also make the opposite determination (i.e., determine optimal assignment of a work item to a resource). In some embodiments, the work assignment engine 120 is configured to achieve true one-to-one matching.

The work assignment engine 120 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In some embodiments, the work assignment mechanism 116 may operate to assign resources and work items in conjunction with a dynamic workforce mechanism 124. The dynamic workforce mechanism 124 may be configured as a module that is capable of analyzing work items and/or resources in determining team workforce assignments. Analysis of a work item can include, but is not limited to, determining a customer identification, work item information, subject matter, attributes, service level, historical data, average time of handling (e.g., including wait times, processing time, disposition time, etc.), past performance, and/or the like. Based at least partially on the analysis of the work item, the dynamic workforce mechanism 124 may determine that a team of resources 112 may be required to handle the work item. In some embodiments, determining whether a team of resources 112 is required to handle the work item may include referring to rules stored in a memory (e.g., memory 136). For instance, at least one rule may define that a team of resources 112 is required for certain customers (e.g., high-value customers, tagged customers, customers who paid for team handling, etc.). As another example, at least one rule may provide that a team of resources 112 is required for a type of subject matter, or combination of subject matter types, associated with a work item.

The workforce engine 132 may reside in the dynamic workforce mechanism 124 or in a number of different servers or processing devices. In some embodiments, cloud-based computing architectures can be employed whereby one or more components of the dynamic workforce mechanism 124 are made available in a cloud or network such that they can be shared resources among a plurality of different users. The workforce engine 132 may be configured to perform the methods associated with the dynamic workforce mechanism 124, as provided herein. For example, the workforce engine 132 may execute, via a processor, instructions that are stored in memory 136 and configured to perform one or more team workforce assignments.

In some embodiments, the workforce engine 132 may dynamically assemble a team of resources 112 for a work item. Assembling a team of resources 112 may include determining a combination of resources 112 having one or more attributes that match information associated with a work item. Additionally or alternatively, assembling a team of resources 112 may include reserving a number of resources 112 in a contact center for a specific amount of time and/or an expected involvement with the work item and/or the team. This specific amount of time and/or the expected involvement may be based, at least partially, on historical information associated with one or more of prior contacts, specific work item types, customer identification, customer type, service level, paid for service, etc. In some embodiments, the specific amount of time and/or the expected involvement may be based, at least partially, on rules store in a memory.

Rules may be stored remotely, or apart, from the dynamic workforce mechanism 124 or workforce engine 132. In some cases, the rules may be stored locally to the work force engine 132 or dynamic workforce mechanism 124. For example, the rules may be stored in memory 136. It is anticipated that the dynamic workforce mechanism 124 may be configured to reserve and/or release resources 112 in team workforce assignments.

Reservations of resources 112 may include marking, via the workforce engine 132, a resource 112 as reserved for a period of time and/or a percentage of utilization. In some embodiments a data structure associated with the resource 112 may be modified to include a reservation status. In one embodiment, the reservation status associated with one or more resources 112 may be stored in a memory (e.g., as information in a table, data structure, and/or other accessible construct). For instance, reservations and/or reservation status may be stored in memory 136.

Resources 112 may be released from a reservation in a team workforce assignment, for example, via the workforce engine 132. Releasing a resource 112 from reservation may include resetting a reservation status value associated with the resource 112. In one embodiment, a data structure associated with the resource 112 may be modified to include a released status. In any event, releasing a resource 112 may allow the resource 112 to return to a work pool for other work assignments (e.g., made via the work assignment mechanism 116, etc.) and/or team workforce assignments (e.g., made via the dynamic workforce mechanism 124, etc.).

The memory 136 may be external to the workforce engine 132 and/or the dynamic workforce mechanism 124. For example, the memory 136 may be maintained in the work assignment engine 120, the work assignment mechanism 116, and/or elsewhere that can be accessed by the dynamic workforce mechanism 124. In accordance with embodiments of the present disclosure, it is anticipated the memory 136 and/or any other memory accessed during the team workforce assignment can be located remotely from, or directly connected to, the contact center. Additionally, the memory 136 may also refer to partitions and/or sections of a memory structure and need not be directed to an entire memory structure. It is anticipated that the dynamic workforce mechanism 124 may be external or internal to the work assignment mechanism 116 and even the work assignment engine 120.

It is an aspect of the present disclosure that the dynamic workforce mechanism 124 may communicate with the work assignment mechanism 116, its components, and/or other contact center components (e.g., the routing engine 128, resources 112, and the like). Work items may be routed at the direction of the dynamic workforce mechanism 124 and/or work assignment engine 120. The routing may include directing the work item to one or more resources 112. Additionally or alternatively, the routing may include altering the assignment of a work item as directed by the work assignment engine 120. In other words, the dynamic workforce mechanism 124 may be incorporated into the work assignment engine 120.

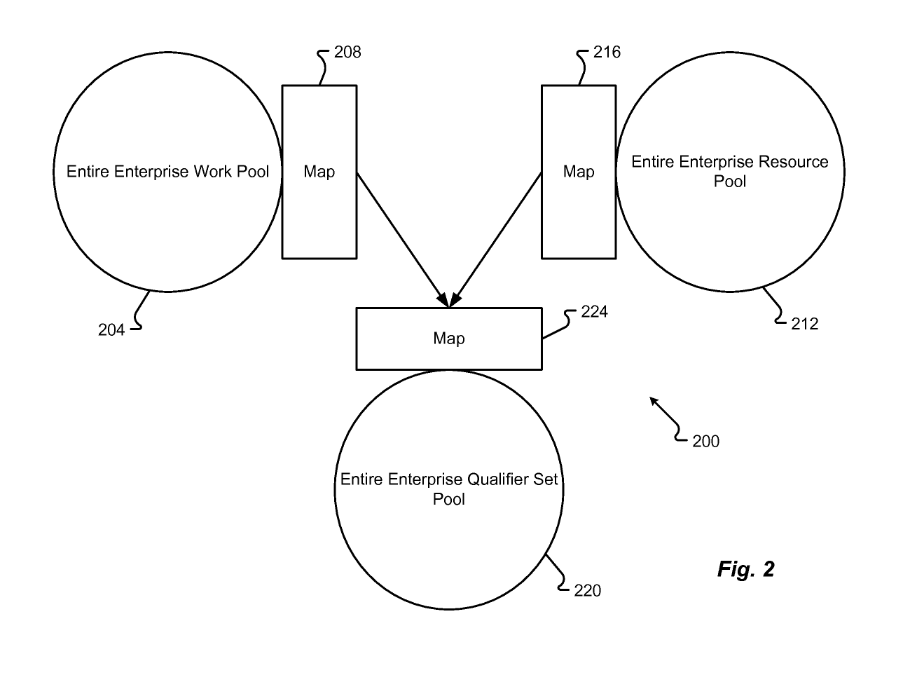

FIG. 2 depicts exemplary data structures 200 which may be incorporated in or used to generate bitmaps/tables used by the work assignment engine 120. The exemplary data structures 200 include one or more pools of related items. In some embodiments, three pools of items are provided, including an enterprise work pool 204, an enterprise resource pool 212, and an enterprise qualifier set pool 220. The pools are generally an unordered collection of like items existing within the contact center. Thus, the enterprise work pool 204 comprises a data entry or data instance for each work item within the contact center.

In some embodiments, the population of the work pool 204 may be limited to work items waiting for service by a resource 112, but such a limitation does not necessarily need to be imposed. Rather, the work pool 204 may contain data instances for all work items in the contact center regardless of whether such work items are currently assigned and being serviced by a resource 112 or not. The differentiation between whether a work item is being serviced (i.e., is assigned to a resource 112) may simply be accounted for by altering a bit value in that work item's data instance. Alteration of such a bit value may result in the work item being disqualified for further assignment to another resource 112 unless and until that particular bit value is changed back to a value representing the fact that the work item is not assigned to a resource 112, thereby making that resource 112 eligible to receive another work item.

Similar to the work pool 204, the resource pool 212 comprises a data entry or data instance for each resource 112 within the contact center. Thus, resources 112 may be accounted for in the resource pool 212 even if the resource 112 is ineligible due to its unavailability because it is assigned to a work item or because a human agent is not logged-in. The ineligibility of a resource 112 may be reflected in one or more bit values.

The qualifier set pool 220 comprises a data entry or data instance for each qualifier set within the contact center. In some embodiments, the qualifier sets within the contact center are determined based upon the attributes or attribute combinations of the work items in the work pool 204. Qualifier sets generally represent a specific combination of attributes for a work item. In particular, qualifier sets can represent the processing criteria for a work item and the specific combination of those criteria. Each qualifier set may have a corresponding qualifier set identified “qualifier set ID” which is used for mapping purposes. As an example, one work item may have attributes of language=French and intent=Service and this combination of attributes may be assigned a qualifier set ID of “12” whereas an attribute combination of language=English and intent=Sales has a qualifier set ID of “13.” The qualifier set IDs and the corresponding attribute combinations for all qualifier sets in the contact center may be stored as data structures or data instances in the qualifier set pool 220.

In some embodiments, one, some, or all of the pools may have a corresponding bitmap. Thus, a contact center may have at any instance of time a work bitmap 208, a resource bitmap 216, and a qualifier set bitmap 224. In particular, these bitmaps may correspond to qualification bitmaps which have one bit for each entry. Thus, each work item in the work pool 204 would have a corresponding bit in the work bitmap 208, each resource 112 in the resource pool 212 would have a corresponding bit in the resource bitmap 216, and each qualifier set in the qualifier set pool 220 may have a corresponding bit in the qualifier set bitmap 224.

In some embodiments, the bitmaps are utilized to speed up complex scans of the pools and help the work assignment engine 120 make an optimal work item/resource assignment decision based on the current state of each pool. Additionally or alternatively, the bitmaps may be utilized by the dynamic workforce mechanism 124 in efficiently identifying and managing resources. Accordingly, the values in the bitmaps 208, 216, 224 may be recalculated each time the state of a pool changes (e.g., when a work item surplus is detected, when a resource surplus is detected, and/or when rules for administering the contact center have changed).

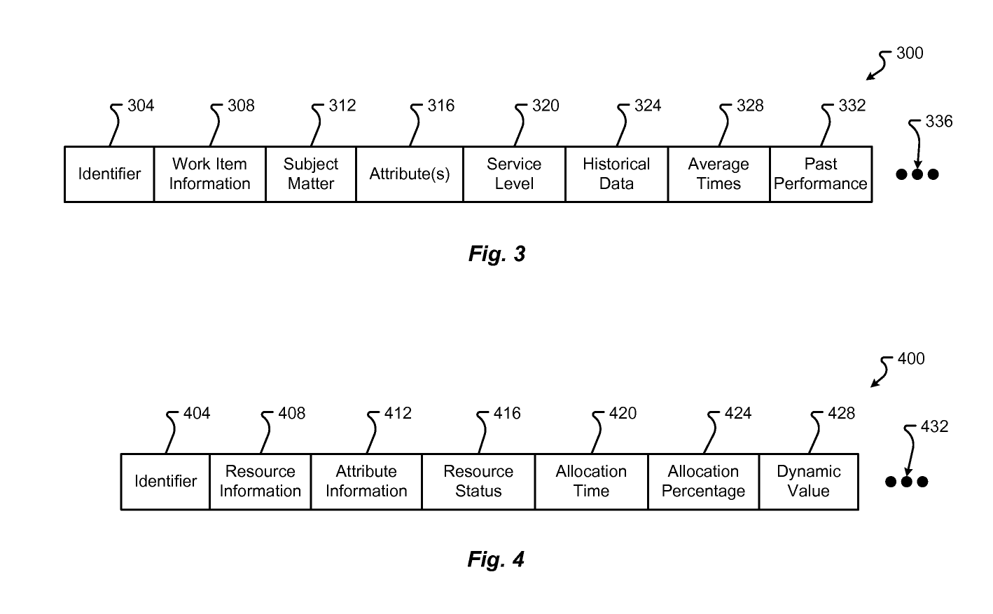

FIG. 3 is a block diagram depicting a work item data structure 300 used in accordance with embodiments of the present disclosure. Specifically, each work item may have a corresponding data structure 300 which identifies the work item in an identifier information field 304, provides customer and work item related data in a work item information field 308, identifies the subject matter of the work item in a subject matter information field 312, identifies one or more required attributes in an attributes field 316, identifies a service level in a service level field 320, includes historical data and past queries in a historical data field 324, includes interaction and contact times in an average times field 328, provides information relating to past interactions with a contact center in a past performance field 328, and more 336.

The identifier information field 304 may comprise data that identifies the work item media type. This field 304 may be used by the dynamic workforce mechanism 124 in directing work items to work assignment and/or one or more resources 112. The identifier information field 304 may be used to track the work item while it is being processed through a contact center. Additionally, or alternatively, the identifier information field 304 may include data to track a work item in real-time (e.g., as the work item is being handled), near-real-time (e.g., as the work item is being handled taking into account any calculation, determination, and/or other system and component delays), or non-real-time (e.g., after the work item is handled). For example, data relating to the handling of a work item may be evaluated after the work item has been handled (e.g., non-real-time) to provide information to improve handling techniques. Among other things the identifier information field 304 may comprise data that can be used to differentiate between various work items received by a contact center.

The work item information field 308 may comprise data that identifies a customer associated with the work item. Additionally, or alternatively, the work item information field 308 may include identification data relating to a specific customer that may be used by, at least, the dynamic workforce mechanism 124 in referring to stored data, preferences, and/or historical information relating to the customer. In one embodiment, the related customer information may be stored in the memory 136 of the workforce engine 132.

The subject matter information field 312 may comprise one or more bits or bit values which identify the subject matter area that is used to appropriately route the work item and/or assemble a team of resources 112 for the work item. This field 312 may include general or specific information relating to the subject matter of the work item. For example, a sample work item may wish to inquire about implementing SIP presence functionality in an existing telecommunications system. As such, the subject matter information filed 312 may be coded to identify SIP presence and implementation as the appropriate subject matter to be used in assembling a team of resources 112 and/or routing and/or pushing the work item to one or more resources 112. As another example, a work item may include “real estate transaction” as a subject matter in the field 312. In response, the dynamic workforce mechanism 124 may assemble a team of resources 112 based at least partially on this subject matter. The team of resources 112 may include a real estate agent, a title expert, a lawyer, a contract specialist, and/or other resource 112 for the work item.

The attributes field 316 may comprise one or more bits or bit values that identify any required attributes associated with the work item. In some embodiments, the work assignment mechanism 116 or its various components (e.g., the work assignment engine 120, etc.) and/or the dynamic workforce mechanism 124 or its various components (e.g., the workforce engine 132, etc.), may utilize information contained in the attributes field 316 to match a work item with a resource 112, or vice versa. As such, one or more of the attributes contained in the attributes field 316 may be matched to one or more attributes associated with a suitable resource 112. For example, the field 316 may include “English” as a required attribute. In one embodiment, the “English” required attribute may indicate that any information (e.g., speech, text, multi-media, etc.) communicated to the contact must be presented in English. Continuing this example, the work assignment mechanism 116 and/or the dynamic workforce mechanism 124 may determine one or more resources 112 that possess the required attribute “English.” As a result, a team of resources 112 may be assembled for the work item, where each resource 112 of the team of resources 112 has the “English” attribute.

In some embodiments, the service level field 320 may comprise one or more bits which describe whether the customer associated with the work item has paid for, or is assigned to, a quality level or grade. For example, the field 320 may be used to identify a service grade (e.g., increasing in grade from lowest to highest, such as, bronze, silver, gold, platinum, etc.) of the work item. In this example, a work item may be treated differently (e.g., given priority treatment, etc.) in routing and/or pushing to one or more resources 112 if it is determined that the customer associated with the work item has paid for the best service levels (e.g., either gold or platinum) available. The priority treatment can include assembling, via the dynamic workforce mechanism 124, a team of resources 112 for handling the work item ahead of another work item having a lower level (e.g., bronze or silver) of service grade (e.g., even if the lower level work item contacted the contact center first in time). In one embodiment, the priority treatment may include assembling a team of resources 112 comprising a number of resources 112 having a high rating value (e.g., related to an efficiency, expertise, attitude, competency, etc., and/or other measure of a resource's abilities). The high rating value may be classified similarly to the service grade associated with the work item. For example, a highly rated resource 112 may have a “gold” or “platinum” rating value. Lower rated resources 112 may have a “bronze” or “silver” rating value. As can be appreciated, resources 112 having “gold” rating values may be selected and assembled via the dynamic workforce mechanism 124 for “gold” service grade work items, while resources 112 having “silver” rating values may be selected and assembled for “silver” service grade work items, and so on. This service level information may be contained in the work item information field 320 of the data structure 300.

The historical data field 324 may comprise data related to historical information associated with a customer. For example, the historical data field 324 may include, but is not limited to, a number of past contacts, past subject matter types, customer satisfaction rating values, when a previous contact was made by the customer, how long the customer has been a customer (e.g., member since, etc.), customer loyalty (e.g., has the customer had an interruption in paid for services, etc.), and the like. The information included in the historical data field 324 can be analyzed via the dynamic workforce mechanism 124 in assembling a team of resources 112 for the work item. For instance, if the customer has a negative satisfaction rating associated with a specific resource 112 (e.g., expressing that the customer was dissatisfied with the specific resource 112, etc.) of the contact center, the specific resource 112 may be excluded from selection for the team of resources 112.

The average times field 328 may comprise data related to handling times associated with the customer and/or the work item. The handling times may include present and/or historical time information. In some embodiments, the field 328 may include wait times, processing times, disposition times, contact times, time length of contacts, and/or the like. The times in this field 328 may be presented as averages, maximums, minimums, individually, and/or combined. For instance, a work item may include an average wait time in this field 328 that indicates the customer has been waiting more (e.g., for a longer period of time, etc.) than other customers at the contact center. Continuing this example, the dynamic workforce mechanism 124 may refer to this field 328 and set a priority associated with assembling a team of resources 112 for the work item. The priority may elevate the work item to have a team assembled in a shorter period of time. In one embodiment, the dynamic workforce mechanism 124 may determine that a priority should be set to drop the work item from the team workforce assignment. As another example, a customer may be associated with longer-than-typical contact times. In this case, the work item may include an average contact length of time that is greater than a predetermined threshold value. In some cases, a customer may be associated with average contact length times that correspond to a predetermined average contact length time value stored in memory. In any event, reservations of the resources 112 (e.g., for the team of resources 112 for the work item) by the dynamic workforce mechanism 124 may be based at least partially on the average time in the field 328. For instance, the resources 112 in a team of resources 112 for a work item having longer-than-typical contact times may be reserved for longer periods of time. As can be appreciated, the resources 112 in a team of resources 112 for a work item having average contact times may be reserved for an average period of time.

The past performance field 332 may include data related to the disposition of work items associated with a customer. Disposition may be based on a percentage of successfully resolved contacts made by the customer and handled by a contact center. For instance, a work item associated with a customer who contacted a contact center four times, having successful resolution in three of the four times, may have a past performance value of 75% stored in the past performance field 332. In some embodiments, the dynamic workforce mechanism 124 may assemble teams of resources 112 in an attempt to improve past performance values (e.g., by assembling higher quality/rated resources 112, by assembling teams in a timely manner, etc., and/or the like).

Referring now to FIG. 4, a block diagram depicting a resource data structure 400 is shown in accordance with embodiments of the present disclosure. Specifically, each resource 112, may have a corresponding data structure 300 which identifies the resource in an identifier information field 404, provides resource related data in a resource information field 408, identifies the attributes of the resource in an attributes field 412, identifies a status of the resource 112 in a contact center via a resource status information field 416, provides at least one time the resource 112 is allocated to a work item in an allocation time field 420, provides an percentage of allocation associated with the resource 112 in an allocation percentage field 424, indicates any dependent resources 112 in a dynamic value field 428, and more 432.

The identifier information field 404 may comprise data that identifies the resource 112. This field 404 may be used by the dynamic workforce mechanism 124 in assembling teams of resources 112 for work items. For instance, the identifier information field 404 may include a resource 112 name, or unique identification. Continuing this example, a work item may be received at a contact center where it is analyzed by a work assignment mechanism 116 and/or dynamic workforce mechanism 124. Upon determining that the work item is a prior customer and has been historically handled, or serviced by, a specific resource 112, the work assignment mechanism 116 and/or dynamic workforce mechanism 124 may use the identifier information to match the resource 112 with the received work item. The matched resource 112 may be selected for inclusion in the team workforce assignment. The identifier information field 404 may be used to track work serviced by the resource 112. Additionally, or alternatively, the identifier information field 404 may include data to track a resource's work in real-time, near-real-time, or non-real-time. For example, data relating to the handling of a work item may be evaluated after the work item has been handled (e.g., non-real-time) to provide information to improve handling techniques. Among other things the identifier information field 404 may comprise data that can be used to differentiate between various resources 112 of a call center.

The resource information field 408 may comprise data relevant to the resource 112 and/or the resource's performance. For example, the resource information field 408 may include, but is not limited to, historical work item handling performance, peer rating, supervisor rating, overall rating value, training status, combinations thereof, and the like. The overall rating value may be classified similarly to the service grade associated with the work item, as provided above. For example, a highly rated resource 112 may have a “gold” or “platinum” rating value. Lower rated resources 112 may have a “bronze” or “silver” rating value. As can be appreciated, resources 112 having “gold” rating values may be selected and assembled via the dynamic workforce mechanism 124 for “gold” service grade work items, while resources 112 having “silver” rating values may be selected and assembled for “silver” service grade work items, and so on. This rating value information may be contained in the resource information field 408 of the data structure 400.

The attribute information field 412 may comprise one or more bits or bit values that identify any attributes associated with the resource 112. In some embodiments, the work assignment mechanism 116 or its various components (e.g., the work assignment engine 120, etc.) and/or the dynamic workforce mechanism 124 or its various components (e.g., the workforce engine 132, etc.), may utilize information contained in the attribute information field 412 to match a work item with a resource 112, or vice versa. As such, one or more of the attributes contained in the attribute information field 412 may be matched to one or more attributes associated with a work item. For example, the field 412 for a particular resource 112 may include the following attributes: “English,” “Sales,” and “Expert.” The work assignment mechanism 116 and/or dynamic workforce mechanism 124 may determine that a work item requires the attribute “English.” Additionally or alternatively, the work item may prefer “Sales.” In any event, the resource 112 may be selected, and/or considered, via the dynamic workforce mechanism 124 for a team of resources 112 where a work item includes the “English” attribute.

The resource status information field 416 may comprise data as to the availability of a resource 112 in a contact center. For instance, the field 416 may indicate whether the resource 112 is at least one of busy, free, away, and the like. In one embodiment, the resource status information field 416 may indicate whether a resource is reserved, partially reserved, fully reserved, released, partially released, and/or combinations thereof. In some embodiments, the dynamic workforce mechanism 124 may refer to the resource status information field 416 of the data structure 400 to determine if a resource 112 can be selected for assignment in a team of resources 112 for a work item. Additionally or alternatively, the dynamic workforce mechanism 124 may modify information stored in this field 416, for example, when reserving and/or releasing a resource 112 for a team of resources 112 for a work item.

The allocation time field 420 may comprise data as to a time of allocation on a team of resources 112. The allocation time may include a specific time and/or duration that the resource 112 is expected to participate with a work item. The allocation time field 420 may include information generated via the dynamic workforce mechanism 124 based at least partially on the time information contained in the average times field 328 of the work item data structure 300. For instance, a team of resources 112 may include three resources 112. Two of the three resources in this example may be allocated to the work item for the entire time that the work item is being handled, while the third resource may be allocated to the team of resources 112 at a first point within that entire time (e.g., at 5 minutes after introduction of the other two resources of the team). Continuing this example, the third resource may be assigned to the team for a duration of 10 minutes. After the duration has passed, the third resource may be released from the team via the dynamic workforce mechanism 124. Among other things, this allocation time may allow the dynamic workforce mechanism 124 to reserve the third resource for times outside of the allocation time for one or more other teams of resources 112.

In some embodiments, the allocation time for a resource 112 may be defined by a start and/or stop allocation time. For example, the dynamic workforce mechanism 124 may determine at a first time to allocate a resource 112 to a team of resources 112 for a work item. The determination may include setting a start time for the resource to begin participating with, or be introduced to, the work item. The stop time may include a time when the resource 112 is no longer required, or in some cases allowed, to participate with the work item. As can be appreciated, the start time may include a time that is in the future. For instance, a team workforce assignment decision may be made via the dynamic workforce mechanism 124 on a first day and the resource 112 may be added to the team of resources on a second different day (e.g., a period of time—seconds, minutes, hours, days, weeks, etc.—can pass between the assignment decision and the introduction of the resource 112 to the work item, etc.).

The allocation percentage field 424 may comprise data that identifies a percentage of utilization of a resource 112. While the resource status field 416 comprises information that can be used by the various components and system disclosed herein to determine an availability of a resource 112, the allocation percentage field 424 includes detailed information relating to an amount of availability, or work bandwidth, for the resource 112. For instance, a resource that has been reserved for 1/20 (e.g., 5%) of the total time that a work item is being handled may accept additional reservations for one or more other teams of resources 112 in this time. In one embodiment, the allocation percentage may indicate that a resource 112 is only partially utilized (e.g., 5% utilized) via a team of resources 112. In this case, the dynamic workforce mechanism 124 may determine that the resource 112 still has 95% capacity, or work bandwidth, to accept additional reservations. The information included in the allocation percentage field 424 may be based on one or more of information stored in the resource status field 420 and information stored in the allocation time field 420.

The dynamic value field 428 may include data that identifies any additional, or dependent, resources 112 that are associated with a resource 112. A dependent resource can include any resource 112 that follows, or is linked with, another resource 112 (e.g., the parent resource). The one or more dependent resources associated with a parent resource may, in some cases, be automatically assigned to any team of resources 112 to which the parent resource is assigned. In some embodiments, the dynamic workforce mechanism 124 need only assign the parent resource to a team of resources 112 and the dependent resources are automatically assigned to the team. Any times for which a dependent resource follows a parent resource (and is assigned to team) may be defined based on a relationship of the dependent resource to the parent resource. For instance, a lawyer may be a parent resource, while a stenographer may be the dependent resource. When the lawyer is assigned to a team via the dynamic workforce mechanism 124 the lawyer may be required to ask the customer whether a third party (e.g., the stenographer, etc.) can be used to record the communication. If the customer agrees, the dependent resource may automatically join the team of resources 112 for a period of time. In the event the customer disagrees, the dependent resource may be automatically denied from joining the team of resources 112 for a period of time.

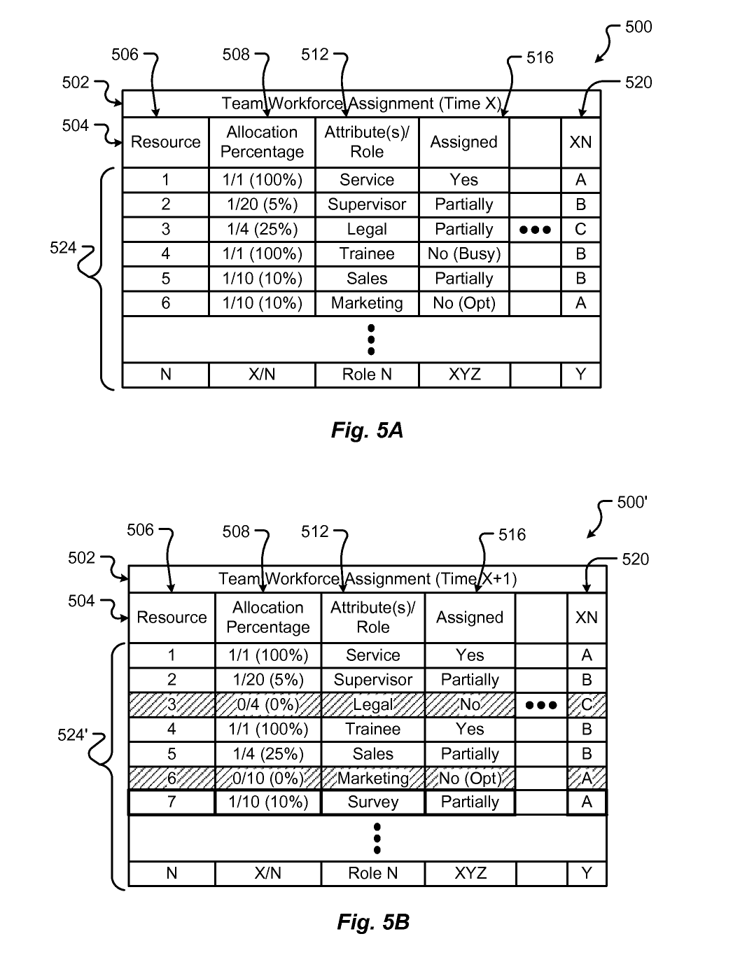

FIGS. 5A and 5B are block diagrams depicting team workforce assignment data structures assembled at various times for a particular work item in accordance with embodiments of the present disclosure. The team workforce assignment data structure 500, 500′ is shown in a tabular format having a number of rows 524, 524′ where each row represents a resource 112 selected via the dynamic workforce mechanism 124 for inclusion on the team of resources 112 for a particular work item. In some embodiments, the team workforce assignment data structure 500, 500′ may include a team identifier 502 that may include one or more of a time the team workforce assignment was generated, an identification of the team workforce assignment (e.g., a name, code, etc.), and/or other data structure information. The team identifier 502 may be configured as a field and/or a row of the table. The data structure 500, 500′ may include a column identification row 504. The column identification row 504 may include a number of column identifiers that serve to identify each column 506-520 of the data structure 500, 500′.

The team workforce assignment data structures 500, 500′ can include several columns 506-520 that represent information about each resource 112 on the team of resources 112. For instance, the team workforce assignment data structure 500, 500′ may include a resource identification column 506, an allocation percentage column 508, an attribute(s)/role column 512, an assignment indicator column 516 and more 520. As shown, “Resource 1” may be allocated for 100% of the work item time duration, with an attribute corresponding to “service,” and is marked as assigned (e.g., shown by the “Yes” field under the assignment indicator column 516). In other words, “Resource 1” can be a part of the team of resources 112 assembled via the dynamic workforce mechanism 124 for the entire expected length of the work item (e.g., contact length of time).

Referring to FIG. 5A, a block diagram depicting a team workforce assignment data structure 500 made for a work item at a first point in time is shown in accordance with embodiments of the present disclosure. The team workforce assignment data structure 500 includes a number of resources 112 having one or more skills/attributes that may be matched to the work item. As provided herein, the dynamic workforce mechanism 124 may dynamically determine a team of resources 112 to handle a work item. In other words, the work item may be evaluated at a number of times (e.g., periodically, continually, and/or in response to a detected change, etc.) during a communication to determine any needs and/or desires of a customer. In evaluating the work item, the dynamic workforce mechanism 124 can refer to and/or analyze one or more fields of a data structure 300 associated with the work item. As the needs and/or desires of a customer change during a workflow, the dynamic workforce mechanism 124 can continually and/or periodically reevaluate a work item for any changes. Changes to the needs and/or desires of a customer/work item determined via the dynamic workforce mechanism 124 may cause an adjustment/modification of the assembly of resources in the team workforce assignment.

FIG. 5B shows a block diagram depicting a team workforce assignment data structure 500′ made for the work item at a second point in time in accordance with embodiments of the present disclosure. As shown, the data structure 500′ made for the work item at the second point in time has changed composition from the data structure 500 made for the work item at the first point in time. As provided herein, the change may be made via the dynamic workforce mechanism 124 based at least partially on a changed need/desire of the work item/customer (e.g., a new need/desire for a resource and/or service, a lack of need/desire for a resource and/or service, etc.), a completion of a service by one or more of the resources 112 in the team, and/or some other detected event (e.g., supervisor intervention, performance decrease, satisfaction decrease, etc.).

In FIG. 5B, “Resource 3” and “Resource 6” have been removed from the team workforce assignment via the dynamic workforce mechanism 124, shown via the cross-hatching in the row for the respective resource (e.g., indicating a removal of the resources 112 from the team). In some embodiments, removal of a resource 112 may be recorded in the data structure 500′ by maintaining at least one field in the data structure 500′. Among other things, this recordation can allow for an analysis of which resources 112 were assembled for a team at a particular point in time. The analysis can be made and/or used by the dynamic workforce mechanism 124 to refine subsequent team workforce assignments and even provide feedback regarding an effectiveness of the dynamic workforce mechanism 124 (e.g., by providing data related to average allocation time for a resource 112, the changing needs of a work item over time, etc., and/or combinations thereof).

In some cases, and as shown in FIG. 5B, a resource 112 may be added to a team work assignment. For example, “Resource 7” is added to the team of resources 112 via the dynamic workforce mechanism 124. The added resource 112 may have a special attribute and/or role that can aid in handling a work item. In some cases, the added resource 112 may be added as part of a training exercise (e.g., where the resource 112 monitors and/or participates in communication with a customer, etc.). In FIG. 5B, “Resource 7” was added by the dynamic workforce mechanism 124 to conduct a survey for the work item. The survey, in this example, may be conducted during an expected time duration associated with the work item or after the expected time duration. As can be appreciated, one or more resources 112 in the team may be released from the team according to a completion of service and/or a completion of the expected duration of time, in accordance with rules stored in memory 136.

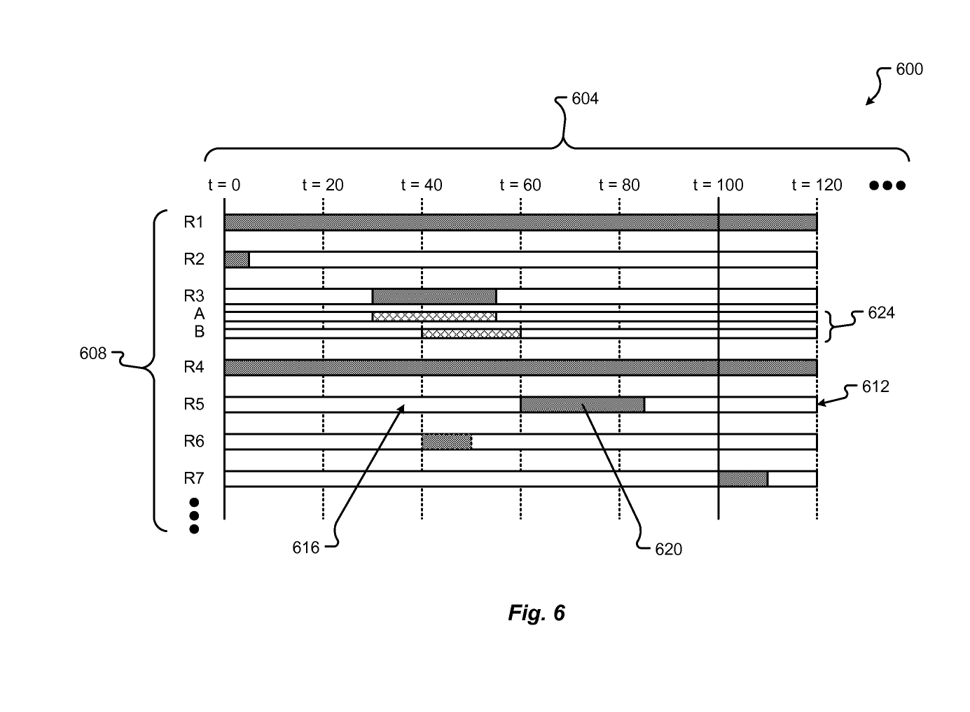

FIG. 6 is a block diagram depicting a team workforce assignment timing diagram 600 in accordance with embodiments of the present disclosure. The timing diagram 600 shows a changing team over time, for example, as a workflow associated with the work item progresses. The timing diagram includes workflow times 604, representing a progression of time associated with the actual duration of a work item. A number of selected resources 608 may be provided that are assembled for the team of resources 112 via the dynamic workforce mechanism 124. Among other things, the timing diagram 600 can represent when a resource 112 is added to the team and for how long a resource 112 participates in the team. For example, the dynamic workforce mechanism 124 may determine to add “Resource 5” to the team of resources 112 at time “t=60.” In this example, “Resource 5” may be assigned to the team for 25 time units (e.g., t=85−60=25), as shown by the allocated time bar 620. Each resource assembled for the team may include a time bar 612 that can include an allocated time bar 620 representing an expected allocation duration and/or percentage for the resource. In some cases, each resource can include an unassigned time bar 616, represented by at least one unfilled area of the time bar 612.

As shown in FIG. 6, the dynamic workforce mechanism 124 can reevaluate a team of resources 112 assembled for a work item at various times 604 in a workflow. In one embodiment, the dynamic workforce mechanism 124 may assemble a team of resources at a first time (e.g., “t=0”), comprising R1 (“Resource 1”), R2 (“Resource 2”), and R4 (“Resource 4”). R1 and R4 may be assigned to the team of resources 112 for an expected duration of the work item (e.g., from “t=0” to “t=100”), while R2 may be assigned to the team of resources 112 for 5 units of time (e.g., “t=5”). As time progresses in the workflow associated with the work item, the dynamic workforce mechanism 124 may continually reevaluate the needs associated with the work item. Continuing this example, at time “t=30” the dynamic workforce mechanism 124 may determine to add R3 (“Resource 3”) to the team of resources 112. R3 may be assigned to the team for a specific amount of expected time (e.g., 25 units of time, etc.) and/or the dynamic workforce mechanism 124 may determine to release R3 upon performing a reevaluation of the needs associated with the work item (e.g., at time “t=55”).

An example of dependent resources following a parent resource is illustrated by the addition of R3 to the team of resources 112. Although the dynamic workforce mechanism 124 adds R3 to the team of resources 112 at time “t=30,” the dynamic workforce mechanism 124 may not determine to add dependent resources A and B. Because R3 is classified as a parent resource, dependent resources A and B follow R3 automatically into the team of resources 112. The dependent resources A and B may follow R3 according to timing and/or rules stored in a memory. Dependent resources A and B are represented by dependent cascading time bars 624 on the timing diagram 600.

In some embodiments, an expected time length, or duration, associated with the work item and/or contact may be determined via the dynamic workforce mechanism 124. The expected duration may be based at least partially on historical data, average times, and/or other timing information stored in a memory. Expected durations can be used by the dynamic workforce mechanism 124 in setting allocation times and/or reservations for resources 112. For example, as shown in FIG. 6, the dynamic workforce mechanism 124 may have determined an expected duration of 100 time units, represented by the vertical line at “t=100.” In other words, the dynamic workforce mechanism 124 expected the overall duration of the work item to last no longer than 100 units. In some cases, the time associated with a work item may need to be extended. Although an actual duration may be shorter than an expected duration, FIG. 6 shows that the actual duration associated with handling the work item increased 20 time units, as represented by the vertical line at “t=120.”

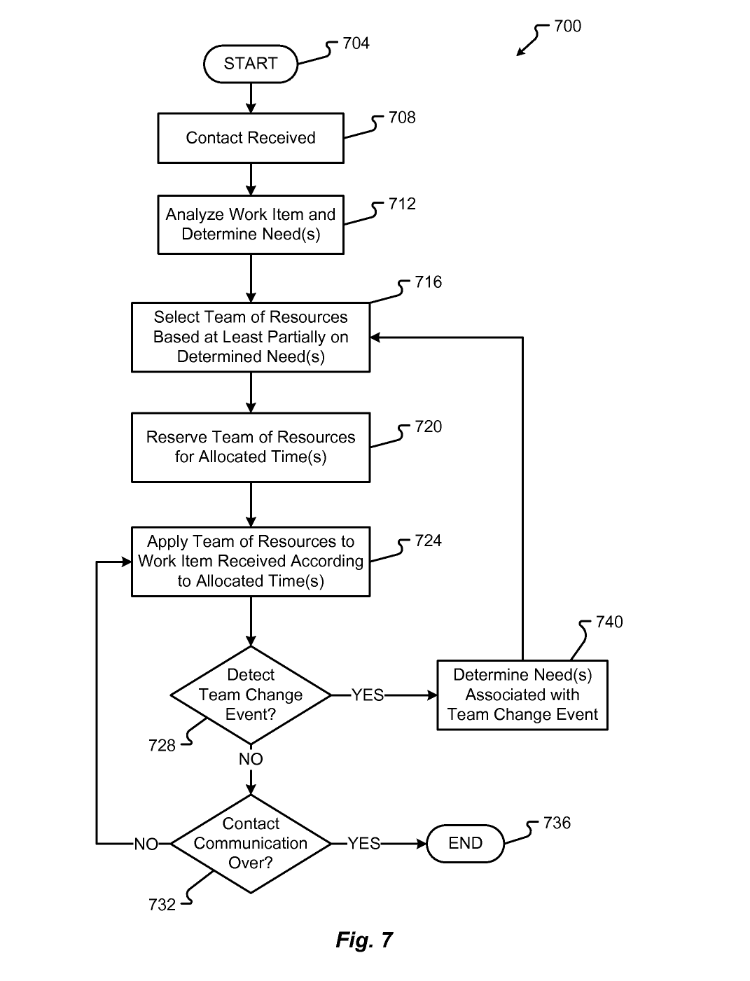

FIG. 7 shows a flow diagram depicting a method 700 of dynamic team workforce assignment in accordance with embodiments of the present disclosure. While a general order for the steps of the method 700 is shown in FIG. 7, the method 700 can include more or fewer steps or can arrange the order of the steps differently than those shown in FIG. 7. Generally, the method 700 starts with a start operation 704 and ends with an end operation 736. The method 700 can be executed as a set of computer-executable instructions executed by a computer system and encoded or stored on a computer readable medium. Hereinafter, the method 700 shall be explained with reference to the systems, components, modules, mechanisms, software, data structures, user interfaces, etc. described in conjunction with FIGS. 1-6.

The method 700 begins at step 704 and proceeds when a contact is received (step 708). In some embodiments, the contact may be received via a work assignment mechanism 116 of a contact center. In one embodiment, the contact may be received via a dynamic workforce mechanism 124. In any event, the received contact may be converted (e.g., via the work assignment mechanism 116 or dynamic workforce mechanism 124) into a work item that represents the contact. The work item can include information about the contact, the customer associated with the contact, needs of the customer, desires of the customer, requested subject matter, historical data, and/or other information.

Next, the method 700 continues by analyzing the work item and determining needs of a customer associated with the work item (step 712). In some embodiments, the needs of the customer associated with the work item may be interpreted as the needs of the work item, and vice versa. Information associated with the work item (e.g., attributes needed, skills needed, subject matter type, etc.) may be provided by a customer associated with the contact. In one example, the attributes may be provided in response to one or more prompts presented by a first resource of the contact center. In some cases, this resource may be a gateway, an Interactive Voice Response (IVR) unit, an operator, combinations thereof, and the like. Determining attributes may include identifying one, some, or all of the required, preferred, and conditional attributes of the work item. In some embodiments the determination may be made by the work assignment mechanism 116 or its various components (e.g., the work assignment engine 120, etc.) and/or the dynamic workforce mechanism 124 or its various components (e.g., the workforce engine 132, etc.).

In some embodiments, needs may be based on information associated with the work item. For example, a work item may include specific resources 112 requested, past assigned resources 112, paid for service level/grade, past performance, and/or the like. The dynamic workforce mechanism 124 may determine that this information is a need of the work item. Any needs of the work item, including preferences, restrictions, and/or combinations thereof can be stored in at least one data field of a work item data structure 300.

The method 700 proceeds by selecting a team of resources 112 based at least partially on the needs determined in step 712 (step 716). In one embodiment, the dynamic workforce mechanism 124 may match a number of resources 112 to the determined needs associated with the work item. The match of a resource 112 to the determine needs associated with a work item may be based on any information contained within the work item data structure 300. The dynamic workforce mechanism 124 may assemble a team of resources 112 based at least partially on the needs of the work item and rules stored in memory 136. Additionally or alternatively, the resources 112 may be selected for a team based on an expected amount of time, or expected duration, of at least a portion of the time that the work item is to be handled. This timing information may be stored in a memory 136, in a data structure 300, 500, 500′, and/or some other memory of the system 100. In some embodiments, the rules may include instructions that define one or more compositions of teams based on one or more of the needs. For example, where a work item includes a subject matter type of “real estate purchase,” the rules stored in memory 136 may define that a team of resources 112 for handling the work item must include at least one sales resource, a real estate lawyer resource, a title expert resource, and a notary resource. Continuing this example, the dynamic workforce mechanism 124 selects individual resources 112 to form a team of resources 112 that match the rules criteria and needs criteria of the work item. Identification of the resources 112 selected for a team of resources 112 may be stored in a memory 136 associated with the dynamic workforce mechanism 124. Additionally or alternatively, the identification of the determined resources may be stored in at least one data structure associated with the resources 112.

Next, the method 700 continues by reserving the team of resources 112 for at least one allocated time (step 720). In some embodiments, each of the resources 112 may be moved from a work-seeking pool to a reserved pool of resources 112. In one embodiment, a resource status of each resource 112 reserved may be set to “reserved.” In other words, each resource 112 may be selectively marked, or tagged, as reserved. As provided herein, resources 112 can be fully reserved, partially reserved, and/or combinations thereof depending on reservation/allocation time and/or duration. When a resource 112 is fully reserved, the resource 112 cannot be reserved for any other team of resources 112 during the time period and/or duration associated with the fully reserved status of the resource 112. When a resource 112 is partially reserved, the resource 112 may be available for one or more other reservations during the time period and/or duration associated with the partially reserved status, providing the other reservations are for no longer than any remaining duration of the partially reserved status. For instance, where a resource 112 is reserved for 1/20 of the time in a duration, other reservations may be made to occupy the other 19/20 of the time in the duration.

Reservations of resources 112 may include a timed or event-based release feature. For instance, the reservation of a resource 112 may expire upon reaching a specific time condition, at which point, the resource 112 may be released from the reservation. As another example, a resource 112 may be released from reservation via the dynamic workforce mechanism 124 determining the resource 112 is no longer needed on the team. In any event, the reservation mark/tag may be removed from released resources 112. The resource status may be included in a data structure 400 of the resource 112 and/or a data structure 500, 500′ of the team of resources 112.

The method 700 proceeds by applying (e.g., assigning) the team of resources 112 to the work item according to predetermined allocation times (step 724). In some embodiments, the entire team of resources 112 may be introduced to a work item at substantially the same time. In one embodiment, the team of resources determined via the dynamic workforce mechanism 124 may be introduced to a work item at different times. By way of example, a customer may need assistance selecting a new pair of shoes. The dynamic workforce mechanism 124 may determine that a team of resources 112, including a design consultant and a sales person are required for the entire duration of the contact with the customer. In this example, the entire team of resources 112 is introduced to the customer at substantially the same time. As another example, a customer may need assistance in preparing a trust fund. The dynamic workforce mechanism 124, in this example, may determine that a lawyer, a bank representative, and a contract specialist are needed to service the customer's needs. However, the dynamic workforce mechanism 124 may introduce the resources 112 at different intervals, such that the contract specialist can collect information from the customer at a first time, the lawyer can review the contract at a second time, and the banking representative can setup the trust at a third time. Among other things, this approach can prevent reserving a valuable resource (e.g., the lawyer, the banking representative, etc.) for an entire duration that a work item is being handled, where the service provided by the valuable resource may not be required for the entire duration.

The method 700 may continue by determining whether a team change event has occurred (step 728). As a workflow associated with handling a work item progresses in time, the dynamic workforce mechanism 124 may reevaluate any needs associated with the work item. Additionally or alternatively, the dynamic workforce mechanism 124 may determine a status of each resource 112 of the team of resources 112 that are applied to the work item. As can be appreciated, the needs of a work item may increase or decrease as a work item is being handled. An increase in the needs of a work item may require additional resources 112 to be added to the team of resources 112. For example, the dynamic workforce mechanism 124 may determine that a new subject matter type has been added to a work item (e.g., via a response from a customer, a comment made in the communication, and/or some other input, etc.). In the event that one or more of the existing resources 112 in the team of resources 112 cannot address the new subject matter type (e.g., the existing resources do not include the subject matter type in any data structure associated with the resources, etc.), the dynamic workforce mechanism 124 will detect this event as a team change event. In the event that one or more of the existing resources 112 in the team of resources 112 can address the new subject matter type (e.g., the existing resources do include the subject matter type in a data structure associated with the resources, etc.), the dynamic workforce mechanism 124 will detect this event as failing to qualify as a team change event. In some embodiments, a decrease in the needs of a work item may permit one or more of the resources 112 to be removed and/or released from the team of resources 112.

In some embodiments, the needs of a work item may be successfully addressed and/or resolved by one or more of the resources 112 in the team. A resolution of a need, inquiry, subject matter type, and/or other desire of the work item may be considered a team change event by the dynamic workforce mechanism 124.

In the event that a team change event is not detected, the method 700 continues at step 732 by determining whether the contact communication is over. If the contact communication is still in progress, the method 700 returns to step 724. However, if the contact communication is determined to be over (e.g., completed, resolved, disconnected, transferred, etc.), the method 700 ends at step 736.

Where a team change event is detected, the method 700 continues at step 740 by determining any needs associated with the team change event. The determination of needs may include analyzing the work item and/or a data structure 300 associated with the work item for any changes. The analysis of the work item for needs may be similar, if not identical, to the analysis performed in conjunction with step 712. Once the needs associated with the team change event are determined, the method 700 may return to step 716 by selecting resources 112 for the team. The needs associated with the team change event may include direction for the dynamic workforce mechanism 124 to add and/or remove resources 112 from the team. As can be appreciated, the method 700 may continually reiterate to provide a dynamically changing team of resources 112 to handle a work item, until the work item has been completed and/or the communication is over. It should be appreciated, that resources 112 may be added and/or removed from a team “on the fly,” or while the team is handling (e.g., communicating with, working with, etc.) the work item. The method 700 ends at step 736.

It should be appreciated that while embodiments of the present disclosure have been described in connection with a queueless contact center architecture, embodiments of the present disclosure are not so limited. In particular, those skilled in the contact center arts will appreciate that some or all of the concepts described herein may be utilized in a queue-based contact center or any other traditional contact center architecture.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving a work item representing a contact from a customer;
determining that the work item includes information corresponding to at least one need of the customer;
determining, based at least partially on the at least one need of the customer, a team of resources having two or more resources for assignment to the work item;
reserving each resource in the team of resources for a period of time;
assigning the team of resources to the work item;
determining, automatically and while the work item is being handled by the team of resources, whether the team of resources requires modification; and
modifying, automatically when the team of resources is determined to require modification and while the work item is being handled by the team of resources, the team of resources by one or more of adding at least one resource to the team of resources and removing at least one resource from the team of resources.

2. The method of claim 1, wherein the at least one need of the customer includes one or more of a subject matter type, an attribute, a service level, and historical data.

3. The method of claim 1, wherein determining the team of resources is based at least partially on rules stored in a memory, and wherein the rules at least define a composition of attributes required for the team of resources based on the at least one need of the customer.

4. The method of claim 1, wherein determining the team of resources further comprises:
determining a group of available resources from a pool of resources;
determining the team of resources from the group of available resources, wherein each resource of the team of resources includes attributes that match the at least one need of the customer.

5. The method of claim 1, wherein reserving each resource in the team of resources for the period of time further comprises:
marking each resource with a reserved status value, wherein the reserved status value is configured to indicate whether each resource in the team of resources is one of partially reserved or fully reserved.

6. The method of claim 1, wherein the period of time includes at least one of an introduction time and a duration of time for each resource in the team of resources, wherein the introduction time corresponds to a time when each resource is first allowed to interact with the work item, and wherein the duration of time corresponds to an amount of time that each resource is allowed to interact with the work item.

7. The method of claim 6, wherein at least one of the introduction time and the duration time is different between two or more resources in the team of resources.

8. The method of claim 1, wherein determining whether the team of resources requires modification further comprises:
detecting a change in the at least one need of the customer;
determining whether the team of resources is capable of handling the work item based at least partially on the detected change in the at least one need of the customer;
determining that modification is required when the team of resources does not include an attribute required by the detected change in the at least one need of the customer; and
determining that modification is not required when the team of resources includes an attribute required by the detected change in the at least one need of the customer.

9. The method of claim 1, wherein at least one resource in the team of resources is a parent resource, wherein the parent resource is associated with at least one dependent resource, and wherein the dependent resource automatically joins the team of resources when the parent resource is assigned to the work item.

10. The method of claim 1, wherein determining the team of resources further comprises:
analyzing historical data for interactions with other work items having similar needs to the at least one need of the customer; and
determining a number and type of resources to include in the team of resources based at least partially on the analysis.

11. A non-transitory computer readable medium having stored thereon instructions that, when executed by a processor, perform a method comprising:
receiving a work item representing a contact from a customer;
determining that the work item includes information corresponding to at least one need of the customer;
determining, based at least partially on the at least one need of the customer, a team of resources having two or more resources for assignment to the work item;
reserving each resource in the team of resources for a period of time;
assigning the team of resources to the work item;
determining, automatically and while the work item is being handled by the team of resources, whether the team of resources requires modification; and
modifying, automatically when the team of resources is determined to require modification and while the work item is being handled by the team of resources, the team of resources by one or more of adding at least one resource to the team of resources and removing at least one resource from the team of resources.

12. The non-transitory computer readable medium of claim 11, wherein the at least one need of the customer includes one or more of a subject matter type, an attribute, a service level, and historical data.

13. The non-transitory computer readable medium of claim 11, wherein determining the team of resources is based at least partially on rules stored in a memory, and wherein the rules at least define a composition of attributes required for the team of resources based on the at least one need of the customer.

14. The non-transitory computer readable medium of claim 11, wherein determining the team of resources further comprises:
determining a group of available resources from a pool of resources;
determining the team of resources from the group of available resources, wherein each resource of the team of resources includes attributes that match the at least one need of the customer.

15. The non-transitory computer readable medium of claim 11, wherein reserving each resource in the team of resources for the period of time further comprises:
marking each resource with a reserved status value, wherein the reserved status value is configured to indicate whether each resource in the team of resources is one of partially reserved or fully reserved.

16. The non-transitory computer readable medium of claim 11, wherein the period of time includes at least one of an introduction time and a duration of time for each resource in the team of resources, wherein the introduction time corresponds to a time when each resource is first allowed to interact with the work item, and wherein the duration of time corresponds to an amount of time that each resource is allowed to interact with the work item.

17. The non-transitory computer readable medium of claim 11, wherein determining whether the team of resources requires modification further comprises:
detecting a change in the at least one need of the customer;
determining whether the team of resources is capable of handling the work item based at least partially on the detected change in the at least one need of the customer;
determining that modification is required when the team of resources does not include an attribute required by the detected change in the at least one need of the customer; and
determining that modification is not required when the team of resources includes an attribute required by the detected change in the at least one need of the customer.

18. The non-transitory computer readable medium of claim 11, wherein determining the team of resources further comprises:
analyzing historical data for interactions with other work items having similar needs to the at least one need of the customer; and
determining a number and type of resources to include in the team of resources based at least partially on the analysis.

19. A contact center, comprising:
a dynamic workforce mechanism contained in memory and executed by a processor, the dynamic workforce mechanism including:
a workforce engine configured to receive a work item representing a contact from a customer, determine that the work item includes information corresponding to at least one need of the customer, determine, based at least partially on the at least one need of the customer, a team of resources having two or more resources for assignment to the work item, reserve each resource in the team of resources for a period of time, assign the team of resources to the work item, determine, automatically and while the work item is being handled by the team of resources, whether the team of resources requires modification, and modify, automatically when the team of resources is determined to require modification and while the work item is being handled by the team of resources, the team of resources by one or more of adding at least one resource to the team of resources and removing at least one resource from the team of resources.

20. The contact center of claim 19, wherein in determining whether the team of resources requires modification, the workforce engine is further configured to detect a change in the at least one need of the customer, determine whether the team of resources is capable of handling the work item based at least partially on the detected change in the at least one need of the customer, determine that modification is required when the team of resources does not include an attribute required by the detected change in the at least one need of the customer, and determine that modification is not required when the team of resources includes an attribute required by the detected change in the at least one need of the customer.
